(19) United States
(12) Patent Application Publication
(10) Pub. No.: US 2008/0077397 A1
(43) Pub. Date: Mar. 27, 2008

(54) Dictionary creation support system, method and program

(75) Inventor: Sayori Shimohata, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/819,547

(22) Filed: Jun. 28, 2007

(30) Foreign Application Priority Data
Sep. 27, 2006 (JP) JP2006-262699

(51) Int. Cl. G06F 17/21

(52) U.S. Cl. 704/10

(57) ABSTRACT

A dictionary creation support system of the present invention includes a saved history data base that stores information related to dictionary registration candidate words and a dictionary creation support history; an input portion that fetches text data sequences; a candidate word extraction/update portion that analyzes the input text data sequences, extracts dictionary registration candidate words, and updates the information related to the dictionary registration candidate words in the saved history data base; a candidate word submission portion that submits, from among the dictionary registration candidate words entered in the saved history data base, those words that meet with determined submission conditions; a registration instruction fetching portion that fetches instructions indicating whether or not the submitted dictionary registration candidate words are to be registered in the dictionary; and a history update portion that updates the dictionary creation support history entered in the saved history data base.

### CROSS REFERENCE TO RELATED APPLICATIONS

The disclosure of Japanese Patent Application No. JP2006-262699 filed on Sep. 27, 2006, entitled “Dictionary Creation Support System, Method and Program”, including the specification, drawings and abstract is incorporated herein by reference in its entirety.

### BACKGROUND OF THE INVENTION

The present invention relates to a dictionary creation support system, a method and a program. More particularly, for example, the invention relates to a dictionary creation support system, a method and a program that are used to support creation of an electronic dictionary used in natural language processing such as machine translation or key word searching.

### DESCRIPTION OF THE RELATED ART

Methods are known for extracting technical terms from input text of a specialist field that has been computerized. Generally, morphological analysis is performed to divide the input text into word units, and then the usage frequency of word sequences formed by sequences of 1 to n words is calculated. Then, the word sequences are output as technical terms in order from those word sequences that have a high usage frequency. Processing is performed on the word sequences such as eliminating word sequences that are determined to be unnecessary based on limits that are set based on parts of speech, or a level of importance is attributed using a given calculation method.

Japanese Patent Laid-open Publication No. 2002-207731 discloses an example of a technology that supports dictionary creation in the above-described manner.

The device disclosed in JP-A-2002-207731 supports dictionary creation by obtaining text information from a home page on the internet, and after performing morphological analysis thereon, extracting katakana words that are targets for registering by the device and their use frequencies, and displaying them on a screen.

### SUMMARY OF THE INVENTION

However, in the device disclosed in JP-A-2002-207731, the processing from extraction of dictionary candidate words to registering them is a single operation, which does not take into consideration previous processing. As a result, the process may involve needless processing. More specifically, for example, terms that previous registration processing has determined do not need to be registered, or terms that have already been output may appear numerous times on the registration candidate word list. On the other hand, candidate words that should be extracted may be missed out because they do not satisfy set conditions for each respective text, like, for example, because they do not have a sufficient usage frequency, but which actually satisfy the conditions in total over a number of processing operations.

As a result, a dictionary creation support system, a method and a program are needed that can inhibit performance of needless processing while registering necessary information in a dictionary.

A dictionary creation support system according to a first invention includes: (1) a saved history data base that stores information related to dictionary registration candidate words and a dictionary creation support history; (2) an input portion that fetches text data sequences; (3) a candidate word extraction/update portion that analyzes the input text data sequences, extracts dictionary registration candidate words that meet determined candidate word conditions, and updates the information related to the dictionary registration candidate words in the saved history data base; (4) a candidate word submission portion that submits, from among the dictionary registration candidate words entered in the saved history data base, those words that meet with determined submission conditions, which include conditions related to the dictionary creation support history; (5) a registration instruction fetching portion that fetches instructions indicating whether or not the submitted dictionary registration candidate words are to be registered in the dictionary; and (6) a history update portion that updates the dictionary creation support history entered in the saved history data base in accordance with processing of at least one of the candidate word submission portion and the registration instruction fetching portion.

A dictionary creation support method according to a second invention uses (0) a saved history data base, an input portion, a candidate word extraction/update portion, a candidate word submission portion, a registration instruction fetching portion, and a history update portion, and includes the steps of: (1) storing information related to dictionary registration candidate words and a dictionary creation support history in the saved history data base; (2) fetching text data sequences using the input portion; (3) analyzing the input text data sequences, extracting dictionary registration candidate words that meet determined candidate word conditions, and updating the information related to the dictionary registration candidate words in the saved history data base using the candidate word extraction/update portion; (4) submitting, from among the dictionary registration candidate words entered in the saved history data base, those words that meet with determined submission conditions, which include conditions related to the dictionary creation support history, using the candidate word submission portion; (5) fetching instructions indicating whether or not the submitted dictionary registration candidate words are to be registered in the dictionary using the registration instruction fetching portion; and (6) updating using the history update portion the dictionary creation support history entered in the saved history data base in accordance with processing of at least one of the candidate word submission portion and the registration instruction fetching portion.

A dictionary creation support program according to a third invention includes instructions that command a computer to function as: (1) a saved history data base that stores information related to dictionary registration candidate words and a dictionary creation support history; (2) an input portion that fetches text data sequences; (3) a candidate word extraction/update portion that analyzes the input text data sequences, extracts dictionary registration candidate words that meet determined candidate word conditions, and updates the information related to the dictionary registration candidate words in the saved history data base; (4) a candidate word submission portion that submits, from among the dictionary registration candidate words entered in the saved history data base, those words that meet with determined submission conditions, which include conditions related to the dictionary creation support history; (5) a registration instruction fetching portion that fetches instructions indicating whether or not the submitted dictionary registration candidate words are to be registered in the dictionary; and (6) a history update portion that updates the dictionary creation support history entered in the saved history data base in accordance with processing of at least one of the candidate word submission portion and the registration instruction fetching portion.

The present invention provides a dictionary creation support system, a method and a program that can inhibit performance of needless processing while registering necessary information in a dictionary.

### BRIEF DESCRIPTION OF THE DRAWINGS

FIG. 1 is a block diagram showing the functional configuration of a dictionary creation support system of an embodiment;

FIG. 2 is an explanatory figure that illustrates an example of the configuration of a saved history data base of the embodiment;

FIG. 3 is an explanatory figure showing an example of the configuration of a dictionary of the embodiment;

FIG. 4 is a flow chart showing a dictionary registration operation of the dictionary creation support system of the embodiment;

FIG. 5 is a flow chart showing an update operation that is performed for the saved history data base of the embodiment;

FIG. 6 is an explanatory figure that illustrates an example of a first result extracted by a term extraction portion of the embodiment;

FIG. 7 is an explanatory figure that illustrates the contents of the saved history data base following performance of the processing of step S3 of FIG. 4 on the extracted result example shown in FIG. 6;

FIG. 8 is an explanatory figure showing the contents of the saved history data base following repeated performance of the processing of steps S4 to S8 of FIG. 4 on the data base contents shown in FIG. 7;

FIG. 9 is an explanatory figure that illustrates an example of a second result extracted by the term extraction portion of the embodiment;

FIG. 10 is an explanatory figure that illustrates the contents of the saved history data base following performance of the processing of step S3 of FIG. 4 on the extracted results example shown in FIG. 10; and

FIG. 11 is an explanatory figure showing the contents of the saved history data base following repeated performance of the processing of steps S4 to S8 of FIG. 4 on the data base contents shown in FIG. 10.

### DETAILED DESCRIPTION OF THE PREFERRED EMBODIMENTS

### (A) Main Embodiment

Hereinafter, an embodiment in which a dictionary creation support system, a method and a program of the present invention are applied to creation of a bilingual dictionary used in mechanical translation will be explained with reference to the drawings.

In the embodiment, the past history is stored, and when dictionary creation process is performed on candidate words for registering in the dictionary that have been extracted from input text (text data), this information is referred to in order to inhibit output of un-required candidate words to the dictionary. In addition, in this embodiment, candidate words that do not satisfy set conditions for registration for just one file can be output to the dictionary if it is determined that the candidate word satisfies the set conditions based on the result of cumulative total processing.

### (A-1) Configuration of the Embodiment

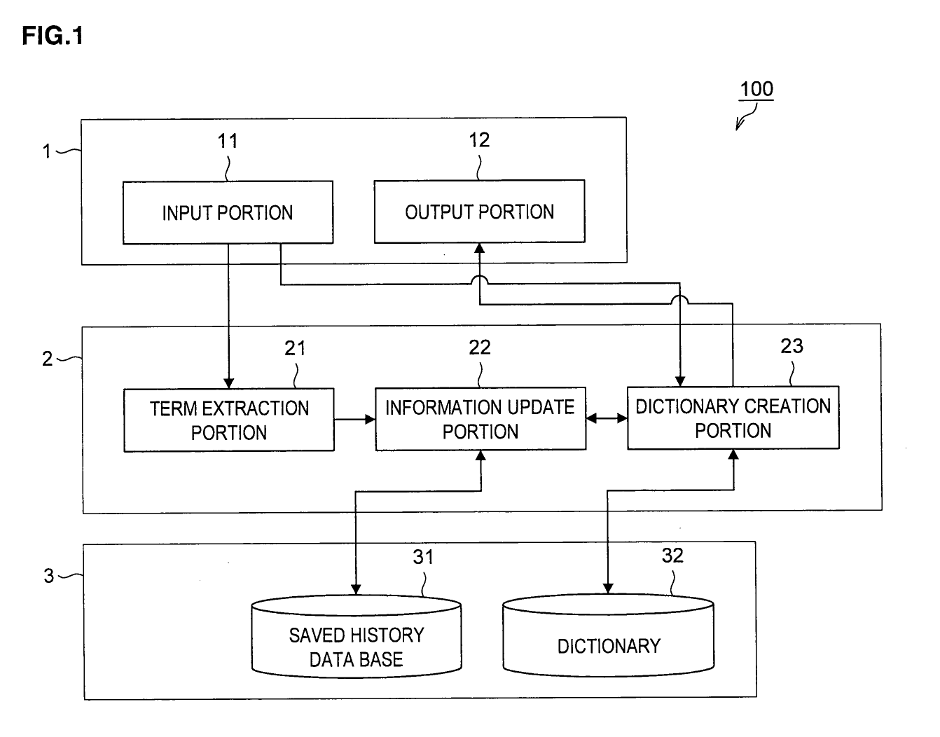

FIG. 1 is a block diagram of the functional configuration of the dictionary creation support system of the embodiment. The dictionary creation support system of the embodiment is configured by installing the dictionary creation support program (including fixed data) of the embodiment on, for example, an information processing device like a personal computer (the information processing device is not limited to being a single unit, and may include a plurality of units that perform distributed processing). FIG. 1 functionally illustrates the dictionary creation support system of the embodiment.

Referring to FIG. 1, a dictionary creation support system 100 of the embodiment principally includes an input output device 1, a processing device 2, and a storage device 3.

The input output device 1 includes an input portion 11 and an output portion 12. The input portion 11 is used to fetch various types of input information, such as a plurality of input texts (text data sequences), and instructions related to registering of registration candidate words, that is used as a basis for creating the content that is registered in a dictionary 31. The output portion 12 is used to output (usually, submit to the user) candidate words for registration in the dictionary 31.

The input portion 11 is able to fetch the various types of input information by use of a pointing device such as a keyboard or a mouse, a scanner and character recognition processing, a microphone and voice recognition processing, or by reading a file. The output portion 12 is able to display the data on a display device, print it using a printer, convert the data to sound and generate a sound output, or output the data to a file.

Note that, the input portion 11 and the output portion 12 may be able to input and output data from/to other devices via a network or a determined circuit. For example, as the input text (the text data sequence), a file that is already stored on the computer or the network may be designated, or the output of an internet search engine may be used without amendment.

The storage device 3 is configured by hardware such as, for example, a hard disk, an optical disk, or a memory, that has a large storage capacity. The storage device 3 includes a saved history data base 31 and a dictionary (dictionary file) 32 as functional units. The saved history data base 31 saves the history of dictionary registration candidate words that have been extracted from the input texts. The dictionary 32 stores information that can be used in mechanical translation, for example, terms and information related to terms.

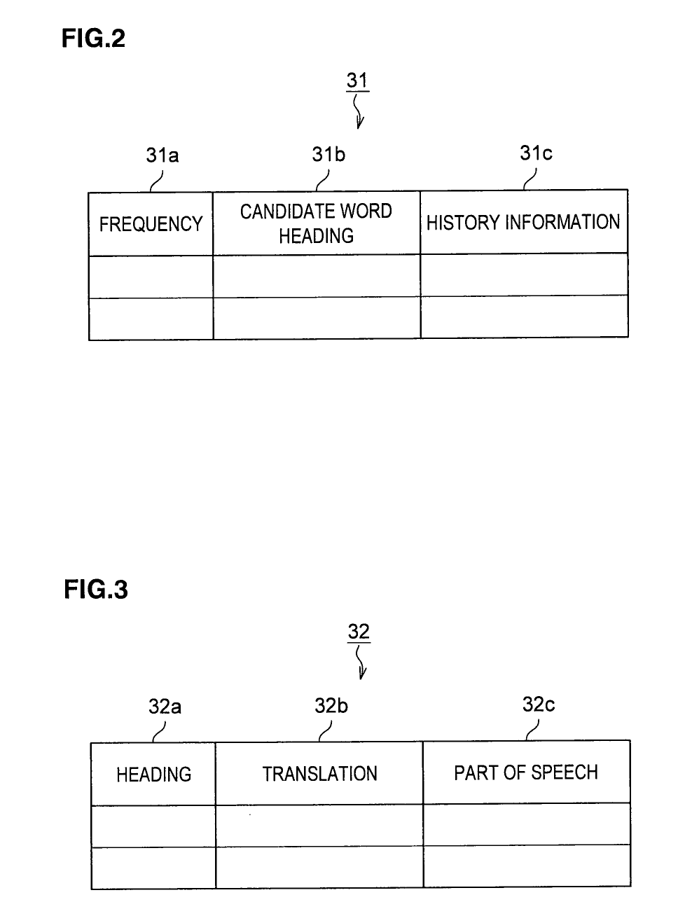

FIG. 2 is an explanatory figure that illustrates an example of the configuration of the saved history data base 31, and FIG. 3 is an explanatory figure showing an example of the configuration of the dictionary 32.

The saved history data base 31 includes a field 31a, a field 31b and a field 31c. The field 31astores information that is used to determine whether or not registration candidate words should be registered or not, namely, their usage frequency or their importance. The field 31b stores the heading of the dictionary candidate word, and the field 31c stores information related to the history, for example, whether or not the user has completed giving instructions related to each candidate word, or whether each word has been fully registered in the dictionary.

The dictionary 32 includes, at the least, a field 32a that stores words or word sequences (headings) of a first language, and a field 32b that stores words or word sequences (translations) of a second language corresponding therewith. In addition, the dictionary 32 may also include a field that stores information required for translation such as information related to parts of speech, and information related to meanings. FIG. 3 shows an example in which the dictionary 32 includes a field 32c that stores information related to parts of speech.

The processing device 2 is configured by hardware such as, for example, a CPU, a ROM, a RAM, an EEPROM, or a hard disk, and is a structural member that can run a dictionary creation support program (excluding the portions of the above-described input output device 1 and the storage device 3).

The processing device 2 includes a term extraction portion 21, an information update portion 22 and a dictionary creation portion 23 as functional units. The term extraction portion 21 extracts dictionary registration candidate words from the input text data sequences (input texts). The information update portion 22 rewrites the contents of the saved history data base 31 based on information related to the extracted terms and information related to the dictionary creation operation. The dictionary creation portion 23 creates the dictionary 32 by determining and outputting dictionary registration candidate words that need to be registered in the dictionary 32 while referring to the contents of the updated saved history data base 31.

Next, the functions of the term extraction portion 21, the information update portion 22 and the dictionary creation portion 23 will be explained in more detail.

The term extraction portion 21 performs morphological analysis processing, usage frequency calculation processing, and the like, on the text data sequences input from the input portion 11, and extracts dictionary registration candidate words that it is determined need to be registered in the dictionary as well as information relate to the usage frequency or the level of importance of the dictionary registration candidate words within the text data (hereinafter referred to as the “evaluation value”).

The information update portion 22 saves the extracted information related to the dictionary registration candidate words in the saved history data base 31. When storage is performed, if the dictionary registration candidate word is already stored in the saved history data base 31, the extracted information related to the candidate word (the evaluation value) and the information stored in the saved history data base 31 are used as a basis for re-calculating the evaluation value. Accordingly, the content of the saved history data base 31 is updated. In addition, as will be described later, the information update portion 22 also updates the information in the saved history data base 31 when information, which indicates whether the user has instructed that a given dictionary registration candidate word is to be registered in the dictionary, is received from the dictionary creation portion 23.

The dictionary creation portion 23 uses the output portion 12 to output (submit) dictionary registration candidate words that meet with pre-set conditions, while referring to the contents of the updated saved history data base 31. In addition, the dictionary creation portion 23 transfers to the information update portion 22 the information about whether the user has instructed that a given dictionary registration candidate word is to be registered in the dictionary.

### (A-2) Operation of the Embodiment

Next, the operation of the dictionary creation support system 100 (the dictionary creation support method of the embodiment) having the above-described functional structure will be explained with reference to the drawings.

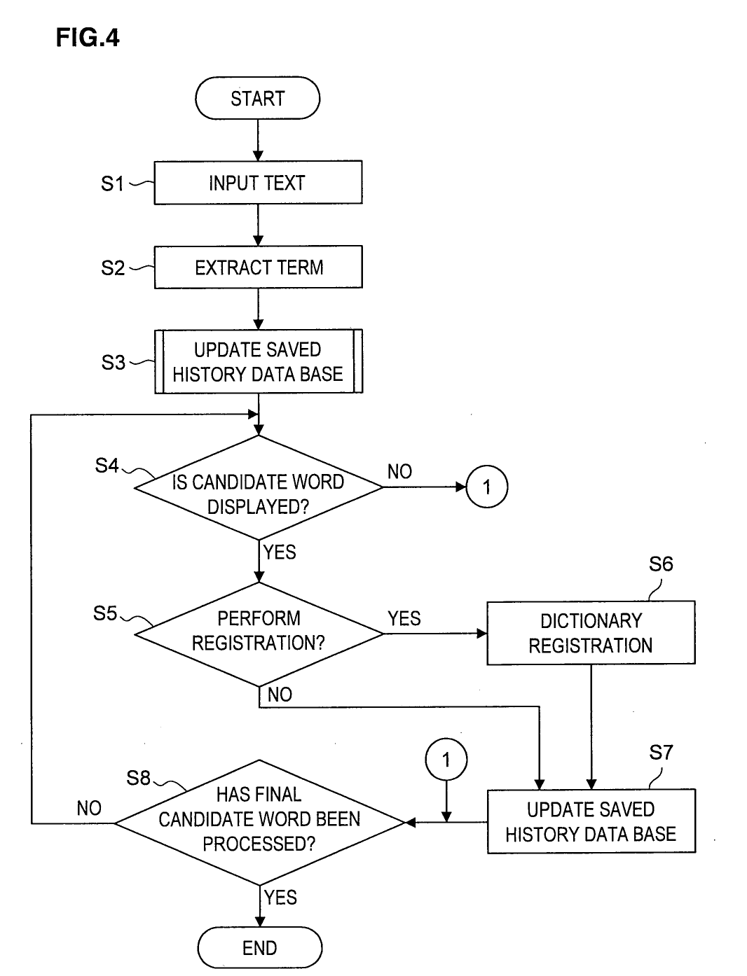

FIG. 4 is a flow chart showing a dictionary registration operation of the dictionary creation support system 100 of the embodiment.

When a text data sequence is input from the input portion 11 (step S1), the term extraction portion 21 performs morphological analysis processing and usage frequency calculation processing and the like on the input text data sequence, and extracts the dictionary registration candidate words that it is determined need to be registered, and their evaluation values (step S2).

As an example of the most simple method of performing the term extraction operation, a method is known, for example, in which the usage frequency of word N-grams are computed from an input text on which morphological analysis has been performed, and then terms that exceed a threshold value are extracted. Furthermore, a method including set limits related to parts of speech, grammar structures or the like, such as extracting just noun sequences, may be applied to the above-described method. In addition, a method may be applied in which computation is used to derive evaluation values of word strings, such as that described in “Extraction of Specialist Terminology based on Usage Frequency and Sequence Frequency” (Authors: Nakagawa, Yumoto and Mori, 2003, Journal of Natural Language Processing, Vol. 10, No. 1, pp. 27-45).

The evaluation value attributed to each term is a value that is calculated using a given calculation formula and the usage frequency of each term in the input text, etc. (for example, dividing the usage frequency by the total term number of the input text).

The information related to the extracted dictionary registration candidate word is stored in the saved history data base 31 by the information update portion 22 (step S3). When storage is performed, if the same dictionary registration candidate word is already stored in the saved history data base 31, the information related to the extracted candidate word and the information stored in the saved history data base 31 are used as a basis for re-calculating the evaluation value, without creating a new record. Accordingly, just the evaluation value is updated.

Next, the dictionary creation portion 23 controls the output portion 12 such that the output portion 12 outputs (for example, on a display) one of the dictionary registration candidate words that meets with the pre-set conditions (for example, having an evaluation value equal to or above a given threshold value, or not being a word that the user has rejected for dictionary registration in the past) while referring to the contents of the updated saved history data base 31 (step S4). The output information related to the dictionary registration candidate word may include not just a word sequence, but also evaluation values, parts of speech etc.

The user determines whether the dictionary registration candidate word is to be registered in the dictionary 32 based on the output contents, and the input portion 11 gives instructions about whether to register the candidate word. When registration is performed, the user inputs necessary information such as a translation, and instructs that registration to the dictionary 32 is to be performed.

In the case that one dictionary registration candidate word has been output, the dictionary creation portion 23 waits for an instruction from the input portion 11 related to whether registration is to be performed or not. When the instruction is received, the dictionary creation portion 23 determines whether the instruction is requesting registration to be performed or not (step S5). Note that, the contents of the instruction related to whether registration is to be performed or not are sent from the dictionary creation portion 23 to the information update portion 22.

If the instruction requests registration to be performed, the dictionary creation portion 23 registers the information related to the dictionary registration candidate word that is presently subject to processing in the dictionary 32 (step S6). In addition, the information update portion 22 writes information that indicates that registration to the dictionary 32 has been performed, information that registration to the dictionary 32 has not yet been performed, or the like, in the saved history data base 31 (step S7).

Once the processing of steps S4 to S7 has been completed for the dictionary registration candidate word that is subject to processing, it is determined whether there are any remaining dictionary registration candidate words that the user has not determined whether or not to register in the dictionary (step S8). In step S8, if it is determined that no more remaining dictionary registration candidate words, the series of processing steps shown in FIG. 4 are ended. In the case that there are remaining dictionary registration candidate words, the processing returns to the above-described step S4.

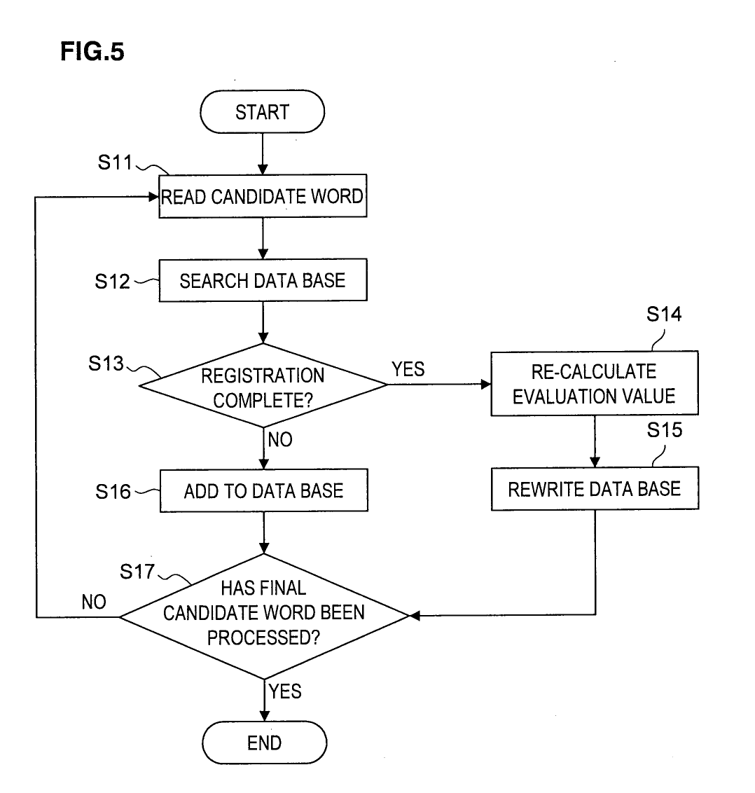

FIG. 5 is a flow chart showing an update operation (step S3 of FIG. 4) that is performed on the saved history data base 31 by the information update portion 22.

When the term extraction operation is ended by the term extraction portion 21, the information update portion 22 starts the processing shown in FIG. 5. First, one word from among the extracted dictionary registration candidate words is read (step S11), and the saved history data base 31 is searched to check whether or not the given dictionary registration candidate word is stored therein (steps S12, S13).

If the given dictionary registration candidate word is already stored in the saved history data base 31, the information update portion 22 re-calculates the evaluation value (step S14), and then updates the information related to the given dictionary registration candidate word contained in the saved history data base 31 (step S15).

On the other hand, if the dictionary registration candidate word read in step S11 is not stored in the saved history data base 31, the information update portion 22 adds an evaluation value and a heading for the given dictionary registration candidate word in the saved history data base 31 (step S16).

The processing like that described above that is performed in steps S11 to S16 is repeatedly performed for all of the extracted dictionary registration candidate words (step S17).

Next, the flow of steps S3 to S6 (the update operation of the saved history data base 31 and the registration operation to the dictionary) will be explained with reference to a specific example.

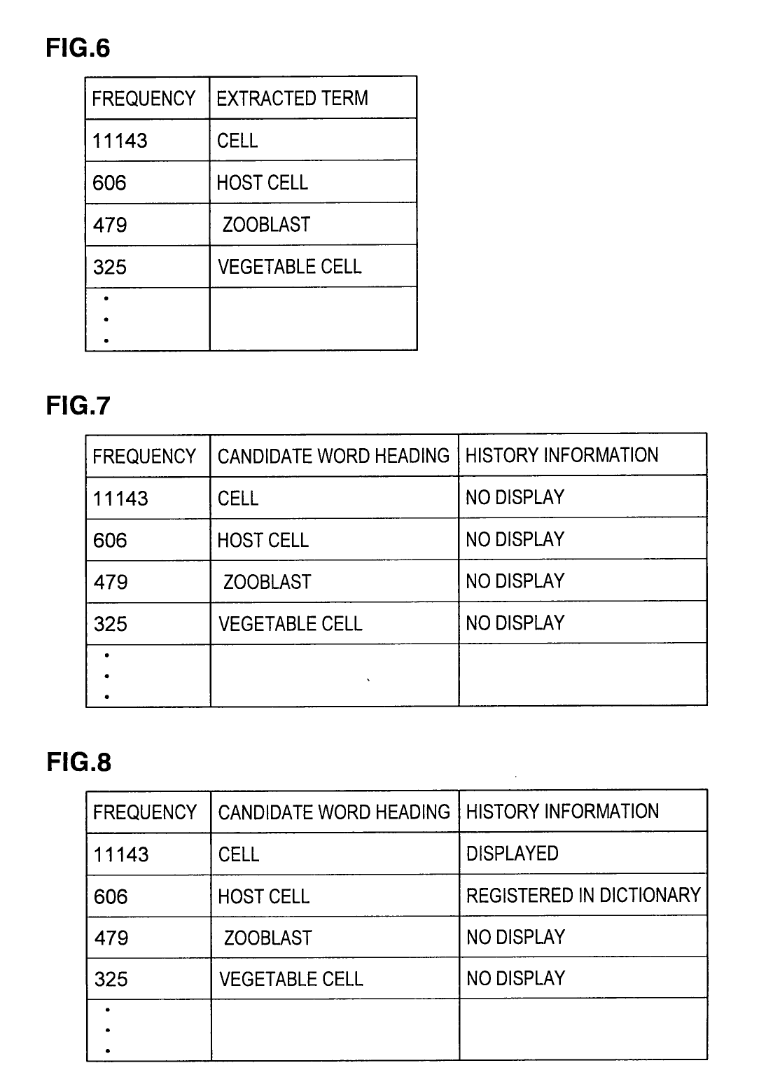

FIG. 6 is an explanatory figure that illustrates an example of dictionary registration candidate words extracted by the term extraction processing. In the example of FIG. 6, the evaluation values of the terms are derived using the usage frequency of the respective words in the input text.

In addition, it is assumed that at the phase at which the dictionary registration candidate words shown in FIG. 6 are extracted, there are no words registered in the saved history data base 31.

In the update operation (FIG. 5) of the saved history data base 31 of step S3, first, based on the results shown in FIG. 6, the first datum, “cell”, is read (step S11). Then, the saved history data base 31 is referred to (step S12), whereby it is determined that the data “cell” is not registered therein (a negative result in step S13). Accordingly, the heading “cell” and the evaluation value (which equals the usage frequency) “11143” are newly added to the saved history data base 31 (step S16).

Processing like that described above is repeatedly performed with respect to the data for second and following dictionary registration candidate words, namely, “host cell”, “zooblast”, and “vegetable cell”.

FIG. 7 is an explanatory figure that illustrates the contents of the saved history data base 31 following processing of the extracted result shown in FIG. 6. It is assumed that the above-described processing was performed when no words were registered in the saved history data base 31, and thus the history information indicates “no display” (no output).

FIG. 7 shows the output (display) generated based on the contents of the saved history data base 31 for the user to determine whether or not registration of each word is to be performed (step S4). In this case, it is determined that words with an evaluation value (usage frequency) of 500 or more (the threshold value) are to be output as dictionary registration candidate words.

The first datum, “cell” of FIG. 7 has a usage frequency of 500 or more, and thus is output as a dictionary registration candidate word (step S4). However, in this case, it is assumed that the user instructs that “cell” is not to be registered in the dictionary (a negative result in step S5). Given this, the information “displayed (output)” is written in the saved history field of the saved history data base 31 (step S7).

Next, the second datum, “host cell”, shown in FIG. 7 also has a usage frequency of 500 or more, and thus it is output as a dictionary registration candidate word (step S4). The user inputs any necessary dictionary information (a translation, the part of speech, etc.) and instructs that the word is to be registered in the dictionary 32 (a positive result in step S5). Then, the word is stored in the dictionary 32 and the information “registered in dictionary” is written in the saved history field of “host cell” of the saved history data base 31 (steps S6, S7).

The usage frequency of the data for the third and following dictionary registration candidate words of FIG. 7, namely, “zooblast” and “vegetable cell” have a usage frequency of less than 500, and thus these words are not output (displayed) for the user to determine whether or not the words are to be registered in the dictionary.

FIG. 8 shows the contents of the saved history data base 31 following repeated performance of the processing of steps S4 to S8 on the contents of the saved history data base 31 shown in FIG. 7.

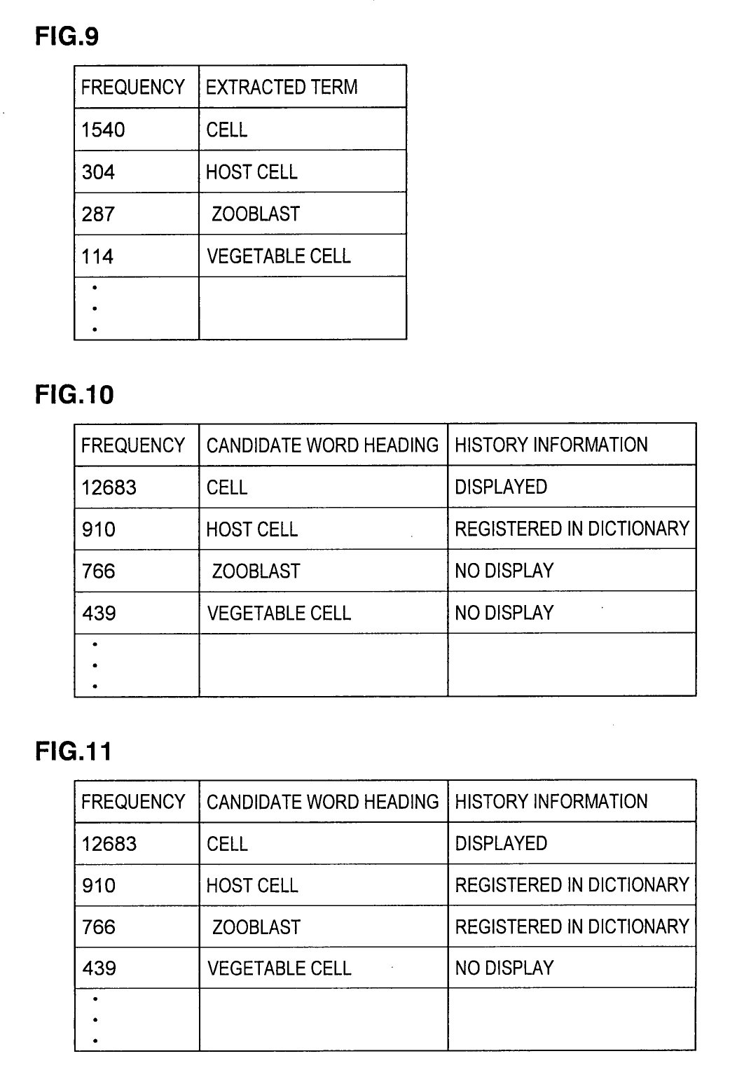

Next, a new input text is input, and the term extraction processing is performed to extract the dictionary registration candidate words shown in FIG. 9.

In the update operation (FIG. 5) of the saved history data base 31 of step S3, first, the first datum “cell” is read based on the results shown in FIG. 9 (step S11). Then, the saved history data base 31 is referred to (step S12), whereby it is determined that the datum “cell” is already registered (a positive result in step S13). Accordingly, the evaluation value is re-calculated (step S14). At this time, the re-calculation method for the evaluation value is based on adding the usage frequency in the saved history data base 31 to the usage frequency of the newly obtained term. Thus, the usage frequency of “cell” in the saved history data base 31, namely, “11143”, is added to the usage frequency shown in FIG. 9, namely, “1540”, to obtain the new usage frequency “12683”. Then, the usage frequency of “cell” in the saved history data base 31 is updated to “12683” (step S15).

The processing described above is repeatedly performed on the data for the second and following dictionary registration candidate words shown in FIG. 9, namely, “host cell”, “zooblast”, and “vegetable cell”.

FIG. 10 is an explanatory figure that illustrates the contents of the saved history data base 31 following performance of the update processing of saved history data base 31 of step S3 on the dictionary registration candidate words shown in FIG. 10.

Next, dictionary registration candidate words are appropriately output (displayed) based on the contents of the saved history data base 31 shown in FIG. 10 (step S4). In this case, the output dictionary registration candidate words are words that have an evaluation value (usage frequency) of 500 or more.

The usage frequency of the first word “cell” in FIG. 10 is 500 or more. However, reference to the history information of the saved history data base 31 indicates that the “cell” is “displayed”. Accordingly, since there is already a history of outputting (displaying) “cell”, the word is not output, and the processing moves to the next datum (a negative result in step S4).

The frequency of the second word “host cell” is also 500 or more. However, since the word is already registered in the dictionary 32, the word is not output (displayed), and the processing moves to the next datum (a negative result in step S4).

The new frequency of the third word “zooblast” is 500 or more, and thus the word is output (displayed) as a dictionary registration candidate word. Assuming that the user instructs that “zooblast” is to be registered in the dictionary, “zooblast” is registered in the dictionary 32, and the information “registered in dictionary” is written in the saved history field of the saved history data base 31 (steps S6, S7).

The usage frequencies of the fourth and following dictionary registration candidate words are below 500, and thus the words are not output (displayed) for the user to determine whether or not they are to be registered in the dictionary.

FIG. 11 shows the contents of the saved history data base 31 following repeated performance of the processing of steps S4 to S8 on the contents of the saved history data base 31 shown in FIG. 10.

### (A-3) Effects of the Embodiment

In the above-described embodiment, when the dictionary registration operation is repeatedly performed on a plurality of input texts (text data sequences), the results of past registration operations are referred to using the history. Accordingly, in the above-described embodiment, terms that have already been determined as not requiring registration and terms that have already been registered etc. in previous dictionary creation processing are no longer submitted as they would be in known technology. Accordingly, repeated operations are eliminated, and operation efficiency can be improved.

In addition, in the above-described embodiment, even if a term is excluded from the dictionary registration candidate words because it does not meet the conditions such as the threshold value in a single performance of the dictionary creation processing, the word may become a candidate word as a result of totaling the results of a plurality of repetitions of the processing. In other words, in the above-described embodiment, it is possible to process a plurality of small texts to obtain similar extraction results as when processing a large text.

### (B) Other Embodiments

The above-described embodiment explains a configuration in which dictionary registration candidate words that have “registered in dictionary” or “displayed” entered in the history information of the saved history data base are not submitted to the user. However, the submission conditions are not limited to those described above. For example, as other possible submission conditions, the dictionary registration candidate words may be displayed along with the history information such as “registered in dictionary” or “displayed”. Alternatively, in the case of “registered in dictionary”, the contents already registered in the dictionary may be displaced.

Furthermore, the above-described embodiment explains a configuration in which the user inputs information related to the translation. However, registration to the dictionary may be performed with the translation column left blank, and a known translation determination method may be used to determine the translation of the blank column. As the translation determination method, for example, the method disclosed in Japanese Patent Laid-open Publication No. 2006-146610, or the method described in “Machine Translation System Capable of Autonomous Vocabulary Expansion, Authors Kamiyama and Ito, presented at the 65^{th} Annual Meeting of the Information Processing Society of Japan, 1B-4, 2003” may be used.

In addition, the above-described embodiment explains a configuration in which dictionary registration candidate words are submitted one at a time to the user who inputs information about whether or not registration is to be performed. However, a batch of words or a given number of words that meet submission conditions may be submitted, while instructions about whether registration is to be performed or not may be made individually. As an example of another embodiment, a given number of dictionary registration candidate words may be displayed on a screen along with check boxes that can be checked to indicate whether registration is to be performed or not. In addition, an execute icon may also be displayed on the screen, and when the execute icon is operated, this may be taken as an instruction to register the words that have a check in their check boxes. Accordingly, the given words are fetched.

Moreover, the above-described embodiment explains a configuration in which support is provided for creating a parallel translation dictionary used in machine translation. However, the present invention may be applied to supporting creation of other dictionaries. For example, the present invention can be applied to creation of a dictionary that includes a keyword and a descriptive text explaining the keyword.

What is claimed is:

1. A dictionary creation support system comprising:
a saved history data base that stores information related to dictionary registration candidate words and a dictionary creation support history;
an input portion that fetches text data sequences;
a candidate word extraction/update portion that analyzes the input text data sequences, extracts dictionary registration candidate words that meet determined candidate word conditions, and updates the information related to the dictionary registration candidate words in the saved history data base;
a candidate word submission portion that submits, from among the dictionary registration candidate words entered in the saved history data base, those words that meet with determined submission conditions, which include conditions related to the dictionary creation support history;
a registration instruction fetching portion that fetches instructions indicating whether or not the submitted dictionary registration candidate words are to be registered in the dictionary; and
a history update portion that updates the dictionary creation support history entered in the saved history data base in accordance with processing of at least one of the candidate word submission portion and the registration instruction fetching portion.

2. The dictionary creation support system according to claim 1, wherein the history update portion enters information in the dictionary creation support history, the information indicating whether given dictionary registration candidate words have been submitted by the candidate word submission portion, and
the candidate word submission portion does not re-submit dictionary registration candidate words that have previously been submitted.

3. The dictionary creation support system according to claim 1, wherein the history update portion enters information in the dictionary creation support history, the information indicating whether the instruction fetched by the registration instruction fetching portion indicates that the given dictionary registration candidate word is to be registered in the dictionary, and
the candidate word submission portion does not re-submit any dictionary registration candidate words that are registered in the dictionary.

4. The dictionary creation support system according to claim 1, wherein the information related to the dictionary registration candidate words in the saved history data base includes a heading for each dictionary registration candidate word, and an evaluation value that is a usage frequency of the dictionary registration candidate word or a statistic calculated using the usage frequency,
the candidate word extraction/update portion updates, in the case that dictionary registration candidate words extracted each time a text data sequence is input are already registered in the saved history data base, the stored evaluation value with a new value that is calculated based on the previous evaluation value and the current evaluation value for the re-extracted dictionary registration candidate word, and
the candidate word submission portion uses whether the evaluation value in the saved history data base is equal to or above a determined threshold value as one of the submission conditions.

5. A dictionary creation support method using a saved history data base, an input portion, a candidate word extraction/update portion, a candidate word submission portion, a registration instruction fetching portion, and a history update portion, comprising the steps of:
storing information related to dictionary registration candidate words and a dictionary creation support history in the saved history data base;
fetching text data sequences using the input portion;
analyzing the input text data sequences, extracting dictionary registration candidate words that meet determined candidate word conditions, and updating the information related to the dictionary registration candidate words in the saved history data base using the candidate word extraction/update portion;
submitting, from among the dictionary registration candidate words entered in the saved history data base, those words that meet with determined submission conditions, which include conditions related to the dictionary creation support history, using the candidate word submission portion;
fetching instructions indicating whether or not the submitted dictionary registration candidate words are to be registered in the dictionary using the registration instruction fetching portion; and
updating using the history update portion the dictionary creation support history entered in the saved history data base in accordance with processing of at least one of the candidate word submission portion and the registration instruction fetching portion.

6. The dictionary creation support method according to claim 5, further comprising the step of:
entering information in the dictionary creation support history using the history update portion, the information indicating whether given dictionary registration candidate words have been submitted by the candidate word submission portion, wherein
the candidate word submission portion does not re-submit dictionary registration candidate words that have previously been submitted.

7. The dictionary creation support method according to claim 5, further comprising the step of:
entering information using the history update portion, the information indicating whether the instruction fetched by the registration instruction fetching portion indicates that the given dictionary registration candidate word is to be registered in the dictionary, wherein
the candidate word submission portion does not re-submit any dictionary registration candidate words that are registered in the dictionary.

8. The dictionary creation support method according to claim 5, wherein
the information related to the dictionary registration candidate words in the saved history data base includes a heading for each dictionary registration candidate word, and an evaluation value that is a usage frequency of the dictionary registration candidate word or a statistic calculated using the usage frequency,
the candidate word extraction/update portion updates, in the case that dictionary registration candidate words extracted each time a text data sequence is input are already registered in the saved history data base, the stored evaluation value with a new value that is calculated based on the previous evaluation value and the current evaluation value for the re-extracted dictionary registration candidate word, and
the candidate word submission portion uses whether the evaluation value in the saved history data base is equal to or above a determined threshold value as one of the submission conditions.

9. A dictionary creation support program that comprises instructions that command a computer to function as:
a saved history data base that stores information related to dictionary registration candidate words and a dictionary creation support history;
an input portion that fetches text data sequences;
a candidate word extraction/update portion that analyzes the input text data sequences, extracts dictionary registration candidate words that meet determined candidate word conditions, and updates the information related to the dictionary registration candidate words in the saved history data base;
a candidate word submission portion that submits, from among the dictionary registration candidate words entered in the saved history data base, those words that meet with determined submission conditions, which include conditions related to the dictionary creation support history;
a registration instruction fetching portion that fetches instructions indicating whether or not the submitted dictionary registration candidate words are to be registered in the dictionary; and
a history update portion that updates the dictionary creation support history entered in the saved history data base in accordance with processing of at least one of the candidate word submission portion and the registration instruction fetching portion.

10. The dictionary creation support program according to claim 9, wherein
the history update portion enters information in the dictionary creation support history, the information indicating whether given dictionary registration candidate words have been submitted by the candidate word submission portion, and
the candidate word submission portion does not re-submit dictionary registration candidate words that have previously been submitted.

11. The dictionary creation support program according to claim 9, wherein
the history update portion enters information in the dictionary creation support history, the information indicating whether the instruction fetched by the registration instruction fetching portion indicates that the given dictionary registration candidate words is to be registered in the dictionary, and
the candidate word submission portion does not re-submit any dictionary registration candidate words that are registered in the dictionary.

12. The dictionary creation support program according to claim 9, wherein
the information related to the dictionary registration candidate words in the saved history data base includes a heading for each dictionary registration candidate word, and an evaluation value that is a usage frequency of the dictionary registration candidate word or a statistic calculated using the usage frequency,
the candidate word extraction/update portion updates, in the case that dictionary registration candidate words extracted each time a text data sequence is input are already registered in the saved history data base, the stored evaluation value with a new value that is calculated based on the previous evaluation value and the current evaluation value for the re-extracted dictionary registration candidate word, and
the candidate word submission portion uses whether the evaluation value in the saved history data base is equal to or above a determined threshold value as one of the submission conditions.
